(19) United States
(12) Patent Application Publication
(10) Pub. No.: US 2002/0057232 A1
(43) Pub. Date: May 16, 2002

(54) Display device

(75) Inventor: Coen Theodorus Hubertus Fransiscus Liedenbaum, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N. V.

(21) Appl. No.: 10/003,061

(22) Filed: Nov. 2, 2001

(30) Foreign Application Priority Data
Nov. 7, 2000 (EP) 00203895.8

(51) Int. Cl. G09G 3/22

(52) U.S. Cl. 345/75.2

(57) ABSTRACT

The invention relates to a display device (1) having pixel elements comprising a luminescent material (7) for emitting light when excited by, e.g. electromagnetic radiation. The pixel elements are provided with electrodes (5,9) which modulate an emission of light by the luminescent material (7) by applying an electric field.

The invention relates to a display device having pixel elements, and to a display apparatus comprising such a display device.

Display devices such as Cathode Ray Tubes (CRTs), Liquid Crystal Displays (LCDs), etc. are well-known. Each type of display has its specific advantages but also its specific disadvantages. For example, CRTs are quite bulky and consume relatively much energy, whereas LCDs have a limited viewing angle and brightness.

It is an object of the invention to provide a display device that mitigates the above-mentioned disadvantages. To this end, the invention provides a display device as defined in claim 1. In this way, a display device is provided that has a good viewing angle and good brightness while combining a low power consumption and a limited display size.

Advantageous embodiments are defined in the dependent claims.

These and other aspects of the invention will be elucidated with reference to the embodiments described hereinafter.

In the drawings,

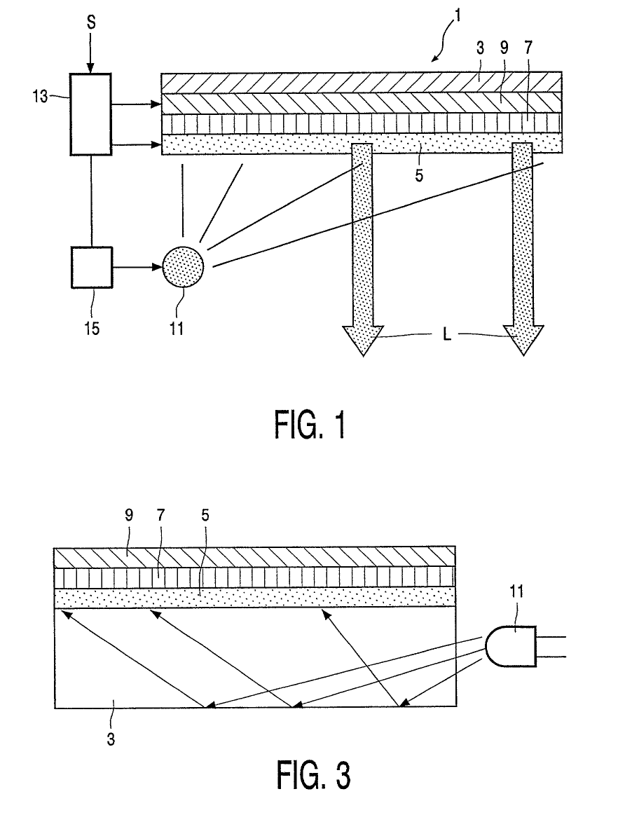

FIG. 1 shows schematically an embodiment of a display apparatus comprising a display device according to the invention;

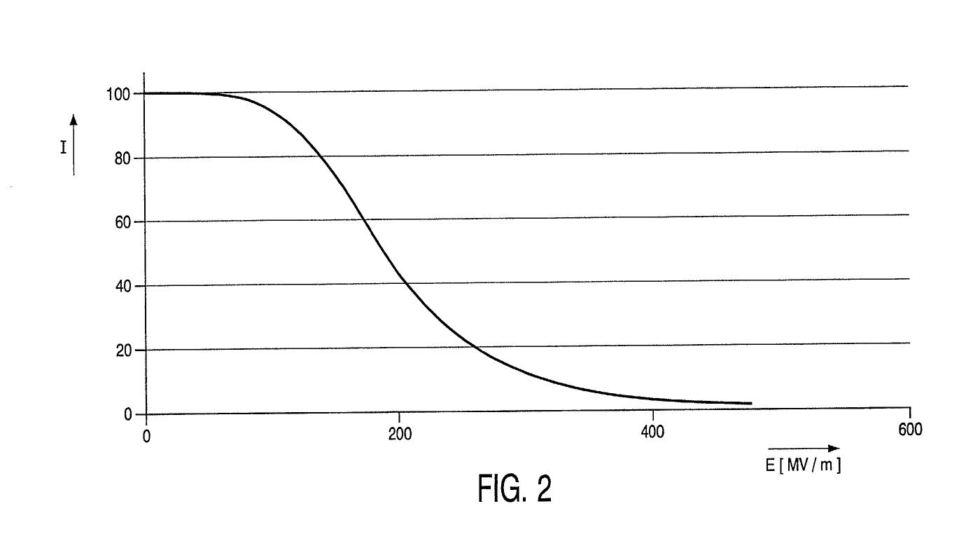

FIG. 2 shows experimental results concerning a polymer that can be used in a display device according to the invention; and

FIG. 3 shows another embodiment of a display device according to the invention.

In general, like reference numerals identify like elements.

FIG. 1 shows schematically the display device 1 according to the invention. A substrate 3 is provided with a stack of layers including a layer 5 of transparent electrode material of, e.g. Indium Tin Oxide (ITO), a thin layer 7 of fluorescent material, e.g. fluorescent polymer, a dye or an inorganic compound like a phosphor, and a layer 9 that forms a back electrode. A source for generating electromagnetic radiation, here for example a UV source 11, is used to induce excitations, so-called excitons, in the layer 7 of fluorescent material. The source can be comprised in the device, but may also be an external source such as e.g. the sun. Such excitons may also be induced by the application of an electric field. Within their characteristic time, these excitations will normally decay to the lowest energy state, i.e. the ground state, of the polymer. In doing so, light, indicated by arrows L in the Figure, is emitted at a wavelength corresponding to an energy difference between an excited state and the ground state. It has been observed experimentally that, if a relatively large electric field is applied to the excitons, the excitons will dissociate into pairs of an electron and a hole (in the case of polymers) and will not decay radiatively. This quenching or inhibition of the normal decay of excitons can be used to modulate light, and a display device can advantageously be based on it. A display apparatus is provided if a display signal S, e.g. a conventional television signal, is used as an input signal for a device 13, which converts the video signal into a modulating voltage that is applied to the electrodes 5,9. The light source 11 is controlled and modulated in relation to the modulating voltage by means of device 15.

FIG. 2 shows experimental results of the light output of a 50 nm thick layer of a yellow emissive conjugated polymer (a Poly Phenylene Vinylene (PPV) derivative) as a function of the applied electric field, when this layer is optically excited. The Figure shows that the intensity I of the emitted light is reduced, when the strength V of the applied electric field is increased (here expressed in Mega Volts/meter). Above a certain value of the electric field, the light output is almost reduced to zero. This experiment was repeated for different layer thicknesses of the fluorescent material, varying between 20 and 90 nm, and different types of fluorescent materials. The outcome of the experiments was always the same: the intensity of the emitted light is reduced when the strength of the electric field is increased and, above a certain field strength, the light output is almost reduced to zero (quenched). A low value of the layer thickness, e.g. 25 nm is preferable in view of a consequent reduction of the driving voltage.

Since the luminescence can be substantially quenched and the curves have a quite moderate slope, the effect is suited for use in displays. By modulation of the amplitude or a pulse width of the applied field, grey scales can be readily induced. If fluorescent materials are used that emit light at different wavelengths, a device emitting at different colors can be created. Such materials can be applied to the substrate by means of, e.g. printing techniques.

A display device having pixels is created e.g. if the electrode layers (5,9) are structured as a matrix, i.e. one electrode layer comprising rows and the other electrode layer comprising columns. Also the display device may comprise pixels in the form of segments that are individually addressable.

In the case of graphic displays, which are suitable for displaying a high information content, active matrix driving may be a preferred method. Such active matrix addressing is known, for example from Thin Film Transistor LCD displays. Each pixel is addressed by one transistor and a hold capacitor. The electric field across the fluorescent layer is then the parameter that is modulated.

Such a display device has the following features:

no viewing angle dependence (fluorescent radiation follows a lambertian distribution curve)

all colors are possible (currently, many fluorescent materials emitting light in a huge range of various colors are available)

high resolution (the resolution is determined by the pitch of the electrodes, which can be very small when photolithographic processes are used)

fast response speeds (the effect is instantaneous)

low power (in principle, no current flows, high-efficiency lamps are applied)

FIG. 3 shows an advantageous embodiment of the display device according to the invention. A transparent substrate 3 is provided with a stack comprising a layer 5 of transparent electrode material, e.g. ITO or PEDOT (a transparent conductive polymer), a layer 7 of fluorescent material and a further layer 9 that forms the back electrode. The transparent substrate 3 is irradiated from a side by a source 11 for generating electromagnetic radiation, e.g. a blue emitting Light Emitting Device (LED). Due to internal reflection within the substrate, the blue light from the LED irradiates the layer 7 of fluorescent material. If an appropriate electric field is applied to the electrode layers 5, 9, the emitted light can be modulated and a picture is displayed.

In summary, the invention relates to a display device 1 having pixel elements comprising a luminescent material 7 for emitting light when excited by, e.g. electromagnetic radiation. The pixel are provided with electrodes 5,9 which modulate an emission of light by the luminescent material 7 by applying an electric field.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The mere fact that certain measures are recited in mutually different dependent claims does not indicate that a combination of these measures cannot be used to advantage.

1. A display device (1) having pixel elements comprising a luminescent material (7) for emitting light when excited by excitation means, each one of said pixel elements being provided with modulating means (5,9) for modulating an emission of light by the luminescent material.

2. A display device (1) as claimed in claim 1, wherein the excitation means comprise means (11) for generating electromagnetic radiation.

3. A display device (1) as claimed in claim 2, wherein the means (11) for generating electromagnetic radiation are comprised in the display device.

4. A display device (1) as claimed in claim 1, wherein the excitation means comprise means for generating an electric field.

5. A display device (1) as claimed in claim 1, wherein the modulating means (5,9) comprise means for applying an electric field to said luminescent material (7).

6. A display device (1) as claimed in claim 4, wherein the pixel elements further comprise electrodes (5,9) which are provided to the luminescent material (7), the electric field being generated by applying a voltage to the electrodes (5,9).

7. A display device (1) as claimed in claim 6, wherein at least one of the electrodes (5,9) comprises a transparent material.

8. A display device as claimed in claim 1, wherein a thickness of a layer of the luminescent material (7) ranges between 10 and 100 nm.

9. A display (1) device as claimed in claim 5, wherein an electric field strength of the electric field varies between zero and 400 MV/m.

10. A display apparatus, comprising:
a display device (1) as claimed in claim 1;
means (15) for controlling said excitation means (11); and
means (13) for controlling said modulating means (5,9) in response to a display signal (S) applied to the display apparatus (1).
